(19) United States
(12) Patent Application Publication
(10) Pub. No.: US 2008/0016339 A1
(43) Pub. Date: Jan. 17, 2008

(54) Application Sandbox to Detect, Remove, and Prevent Malware

(76) Inventor: Jayant Shukla, Sierra Madre, CA (US)

Correspondence Address: Jayant Shukla, 124 vista circle drive, Sierra Madre, CA, 91024, US

(21) Appl. No.: 11/769,297

(22) Filed: Jun. 27, 2007

Related U.S. Application Data
(60) Provisional application No. 60/806,143, filed on Jun. 29, 2006.

(51) Int. Cl. H04L 9/00

(52) U.S. Cl. 713/164

(57) ABSTRACT

The disclosed invention is a new method and apparatus for protecting applications from local and network attacks. This method also detects and removes malware and is based on creating a sandbox at application and kernel layer. By monitoring and controlling the behavior and access privileges of the application and only selectively granting access, any attacks that try to take advantage of the application vulnerabilities are thwarted.

### CROSS REFERENCE TO RELATED APPLICATIONS

This application is derived from the provisional patent application No. 60806143 (EFS IS: 1097247, Conformation number:2476) filed on Jun. 29, 2006.

### BACKGROUND OF THE INVENTION

Hackers frequently exploit vulnerabilities of communication channels and applications to reach potential targets and gain access unauthorized access. Attacks that exploit unknown vulnerabilities are referred to as zero-day attacks and it is very difficult to defend against these attacks [1] [2]. Attacks that exploit known vulnerabilities, while easier to defend against, are very common as the number of computers without up-to-date security patches is very high. For example, the windows metafile (WMF) exploit was being used by attackers long after a patch was issued by Microsoft.

Web, e-mail, instant messengers (IMs) are some of the most frequently used applications that are target of these attacks and provide attack vectors. These attacks mostly go undetected by traditional firewalls that are either do not have the foundations to examine and block the attacks or cannot cope with the volume of data going back and forth.

The web browser and IM based attacks are gaining popularity over e-mail based attacks because of several reasons. First, while user is surfing the web or is online, it becomes possible for the hacker to gain access to the user's machine in real time by exploiting vulnerability in the web browser and thereby propagate the attack faster. With e-mail, the attack payload can be examined using signatures for malicious content before it is delivered to the application, but such an approach is very difficult for real-time applications such as web browsers and IM clients. Even in case of delay insensitive application like e-mail, signature based scanning will not detect zero-day attacks.

Unlike the e-mail, there are no restrictions on the amount of data that can be sent or received by the end user and that enables the potential attacker to mount many more sophisticated attacks. If the attacker can exploit vulnerability in an application on user's machine, they can virtually take complete control of the machine and remotely install various spyware, rootkits, keyloggers, and Trojans. Unlike other malware, Trojans masquerade as benign applications, thereby making them harder to detect. The installed software enables an adversary to control the target computer or device. Intrusion agents such as Trojans and network worms have done considerable harm to networks and are expected to become even more damaging. The installed malware can even remain hidden by using rootkit technology and evade detection by common security applications [3].

Once the adversary has the control of a remote computer, they can use that control to gain information from the computer, launch attacks on other computers, or cause the computer to misbehave. Most denial of service (DoS) or distributed DoS (DDoS) that take place on the Internet happen with the aid of Trojans. Hackers are using the compromised computers to generate revenue by pushing advertisements to it, without the user's consent. While it is possible to scan and clean the infected computers based on signatures, some malware can actively hide or morph itself and make its detection and removal near impossible.

Developments in malware technology pose a very serious threat to any nation or corporation's network and computing infrastructure. With the increased involvement of organized crime syndicates and terrorist organizations in online fraud, the situation is getting worse.

Traditional approaches are either “signature-based” or “anomaly-based” and rely on detecting specific files, registry entries, files of certain specific size, communication on ports commonly associated with Trojans, dramatic changes in traffic patterns and/or application behavior, etc. U.S. Pat. No. 7,013,485 [4] is an example of “user centric” sandbox. U.S. Pat. Nos. 6,351,816, 6,308,275, 6,275,938 [5][6][7] describes another method for sandboxing an application downloaded over the network, but it is focused on preventing the downloaded application from doing damage and not preventing an attack or malware via a trusted or previously installed application. An example of signature-based sandbox is in U.S. Pat. No. 6,298,445 [8] where the system is scanned for known vulnerabilities and patches are applied. Yet another U.S. Pat. No. 6,199,181 [9] tries to create a sandbox by restricting applications access to each others memory space, but it will have almost no ability to prevent an external attack that exploits its vulnerabilities. A new filed application 20060021029 [10] uses virtualization to assess the maliciousness of a downloaded file, but virtualization is very resource intensive, does not actually block the attacks and protects application against exploits.

These traditional approaches suffer from high false positives are easily defeated by slight changes in any or all of the standard parameters used for detecting the malware or Trojans. In extreme cases the malware may hide itself inside the kernel or common applications and completely bypass detection from the signature or anomaly based methods. They may even use rootkit technology to evade detection. It is expected that such methods may be used for financial frauds, industrial espionage, or to aid terrorism. Current methods for malware detection are either unable to prevent such intrusions or are having very limited success. Recently Microsoft and McAfee announced that it may be impossible for them to address the really difficult malware [11][12]. U.S. Pat. No. 5,951,698 [13] is an example where a virus or malware can be removed from a file. Similarly, U.S. Pat. No. 6,772,345 [14] is an example where a malware can be detected and removed from a data stream. However, none of these methods are able to remove malware, in real time, that is executing inside the application or process.

Therefore, a need exists for systems and methods to improve protect against attacks that exploit application vulnerabilities and to remove infestations from compromised system. Such a solution will not only save corporations several billion dollars each year, but it will be critical in maintaining the integrity of government and financial network infrastructure.

### SUMMARY OF THE INVENTION

The present invention provides a new system and method for removing malware and protecting applications against attacks that exploit application vulnerabilities or loopholes to gain unauthorized access into a network or computing device. This approach is significantly different from traditional approaches for intrusion prevention and is “application centric.”

In one embodiment of the present invention secures application or any other module in memory with a sandbox that allows that module or application to function properly while preventing attacks from succeeding and causing any harm. For purposes of clarity the term sandbox as used herein means a method to restrict actions taken by an application or a module.

The sandbox for any application is defined by API function calls that determine its interaction with the operating system and are needed by application to function and by other parameters that can restrict any action by the application that can cause irreversible harm or even temporary malfunction. Applications protected by sandbox are able to thwart attacks that exploit vulnerabilities in that application to gain unauthorized access.

The sandbox itself is elastic that is elastic in nature and morphs based on external parameters such as the website or IP address visited by the user, external components installed inside the application, and interaction of the application with other applications on the system.

In another embodiment of the present invention, any malicious content that may reside inside an application that can potentially render the sandbox ineffective is detected and neutralized. The malware is detected based on its behavior, signature patterns, and code authentication. The behavior classification is based on actions taken by applications such as network access, file and registry modification, API function interception, creation of executable content, stealth behavior, modification of system calls etc. There have been attempts to authenticate programs for a computer U.S. Pat. No. 6,779,117 [15] where the programs are scanned for malicious content, patch level, change detection etc., but they are unable to address the case where the malware loads at a later stage or the programs starts before the scanning can be done. Sometimes, scanning may not work because the malware signature is not available. Our method overcomes these limitations by checking the in-memory image with the on-disk image that is translated to expected in-memory image.

The malware content inside an application or otherwise can also be detected based on how it interacts with other applications. The expected or observed behavior of the application includes actions such as opening other applications memory space, monitoring their keyboard events, monitoring data in the clipboard, and making unauthorized network connections.

In addition to using a sandbox to limit or eliminate attacks via the applications, the present invention is also able to remove or neutralized malware on disk and in memory. In one embodiment, the malware is removed by neutralizing its regenerative ability while in another embodiment, all traces of malware in memory and on disk are removed.

### BRIEF DESCRIPTION OF THE DRAWINGS

Various embodiments of the present invention taught herein are illustrated by way of example, and not by way of limitation, in the figures of the accompanying drawings, in which:

FIG. 1 shows actions and interaction of an application 1 with other applications 2, OS 4, 5, 6, 7.

FIG. 2 illustrates construction of sandbox 9 and sample sandbox rules 10 to allow 11, 13 or deny 12, 14 actions by or towards the application 1, consistent with one embodiment of the present invention.

FIG. 3 shows that the stack examination to obtain the return address 23 can be used to establish the identity of the module responsible for originating an API function call.

FIG. 4 illustrates how a module 36 is injected into the memory space of an application 26 that will create sandbox, consistent with one embodiment of the present invention.

FIG. 5 shows how all areas 27, 28, 29, 30, 31, 32, 33, 34, 35 inside a module or an application 36 are checked for unauthorized hooks or interceptions of function calls.

FIG. 6 illustrates how a module intercepts functions calls inside an application to create sandbox that is consistent with one embodiment of the present invention.

FIG. 7 illustrates the hooking of API function calls 39 40 made by a driver by intercepting the function calls 42 43 inside the body of the module that is consistent with one embodiment of the present invention.

FIG. 8 illustrates a flowchart for one method used by to determine any modifications to any module loaded in memory that is consistent with one embodiment of the present invention.

FIG. 9 illustrates flowchart of one method used to disable a regenerative malware that is consistent with one embodiment of the present invention FIG. 10 shows couple of methods on how a malicious code 56 in memory is neutralized 58, 59, 62, 63 by modifying the malicious code in memory that is consistent with one embodiment of the present invention.

FIG. 11 shows another method on how a malicious code 56 in memory is neutralized 71 that is consistent with one embodiment of the present invention.

FIG. 12 illustrates flexible sandbox that changes it boundaries 75, 76 based on certain conditions 79 that is consistent with one embodiment of the present invention.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DESCRIPTION OF THE PREFERRED EMBODIMENT

In the following paragraphs, the present invention will be described in detail by way of example with reference to the attached drawings. While this invention is capable of embodiment in many different forms, there is shown in the drawings and will herein be described in detail specific embodiments, with the understanding that the present disclosure is to be considered as an example of the principles of the invention and not intended to limit the invention to the specific embodiments shown and described. That is, throughout this description, the embodiments and examples shown should be considered as exemplars, rather than as limitations on the present invention. Descriptions of well known components, methods and/or processing techniques are omitted so as to not unnecessarily obscure the invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

In one embodiment of the present invention, a network accessible computer system with plurality of operating systems and applications is protected using a sandbox against attacks that exploit application vulnerabilities. The application sandbox prevents attacks, detects and removes malware based on an elastic or adaptive limits on application behavior. Sandbox for an application, or a module inside the application, is a collection of rules that enforce the limits on its actions. The sandbox operates by establishing boundaries for application behavior that the application must not exceed. The behavior of an application includes actions such as file system access, network access, registry access, data transfer, code execution, system monitoring etc. Given a set of rules, the sandbox can ensure that the application does not exceed the bounds as specified by the rule set.

The sandbox boundaries themselves are not static and can be tightened or relaxed based on operational parameters such as the user identity, current network connections, etc. These boundaries established by the sandbox can also change, tighten or relax, the security provided by the sandbox based on which component or module inside the application is executing. For example, if the web browser is executing a downloaded ActiveX or JavaScript, then the sandbox is tightened to further restrict changes to the system which in turn limits the damage that can be done by the external piece of software.

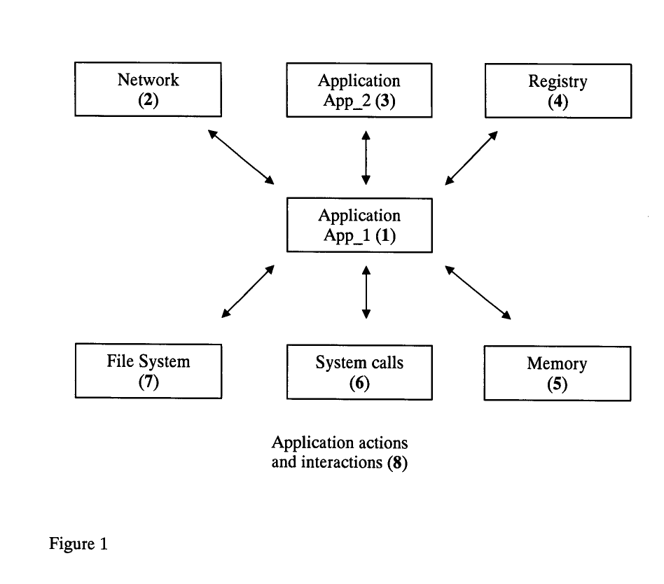

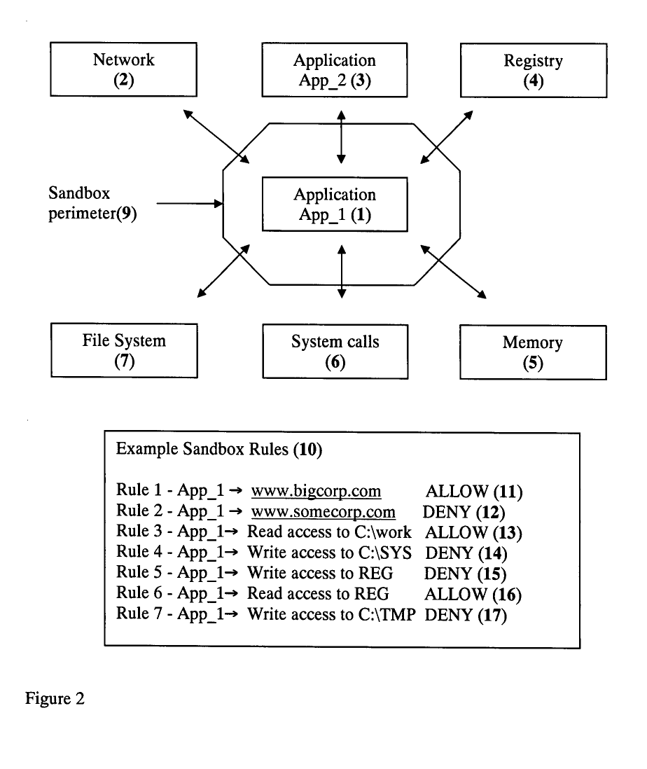

As shown in FIG. 1 and FIG. 2, the sandbox parameters are defined by actions on objects that can detect and block potential adverse effects resulting from an attack or malware, but does not interfere with the normal execution of the valid application 1 and allows it to function as intended. Some of the actions and objects are registry entries 4, file system access 7, network connections 2, ability to execute code 6, etc., but are not limited to them. For anyone well versed in the art, it will be easy to understand how this concept can be applied to any computing device or application.

The sandbox 9 for any application or module, as shown in FIG. 2, is constructed by loading a module or executable code into the application 1. If necessary, another component may be loaded into the kernel. The sandbox is able to control the interaction of the application 8 with other components of the system 2, 3, 4, 5, 6, 7.

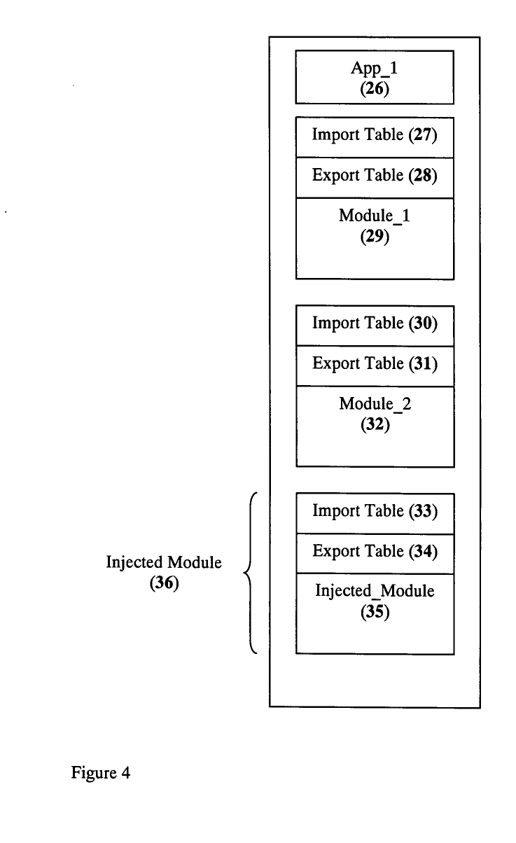

FIG. 4 shows the injected module 36 that could be a dll, a driver, or a direct write into the memory space of that application or a module inside the application or a driver. This module serves the dual purpose of malware detection and enforcement of the sandbox rules 16 for the application of module. In addition, it can create a sandbox for the entire application or individual modules 29, 32 within the application 26.

It is an object of the present invention to provide a method for monitoring behavior of a number of applications or modules in a computing device. One method may inject a module into the memory space of the applications. This injected module may monitor the applications file system access or network access by intercepting its API function calls through imported or exported functions table patching and inline hooking of functions at the application layer. Additionally, the injected module may monitor the applications executable content, memory access, and registry access in a like manner. In one embodiment, the behavioral monitoring method is applied to a specific module inside the application.

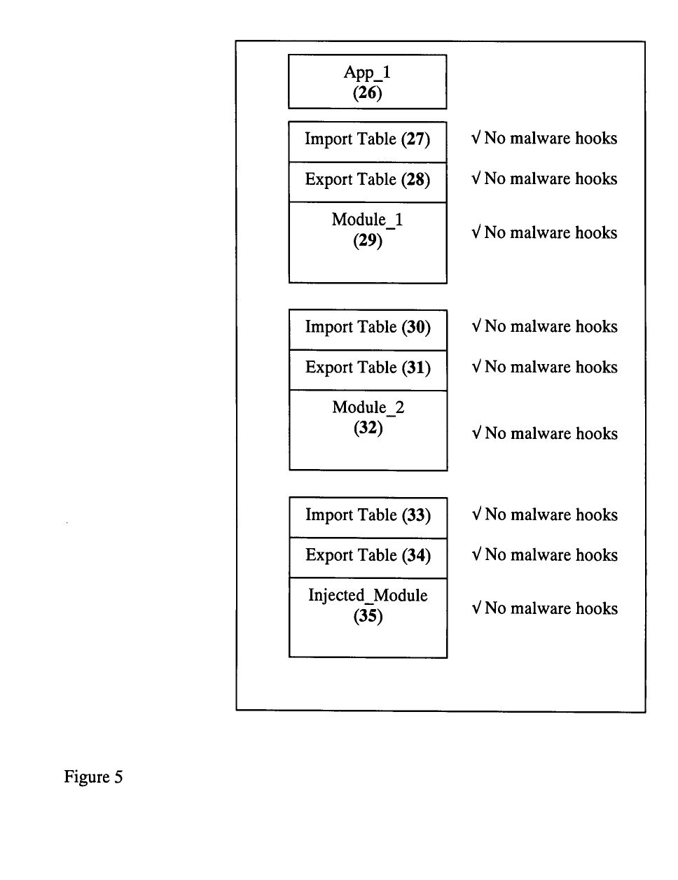

Before the injected module creates hooks to establish a sandbox, an audit is performed. As shown in FIG. 5, the entire space of the module to be protected by the sandbox is examined for any unauthorized hooks that could lead to malicious action by malware.

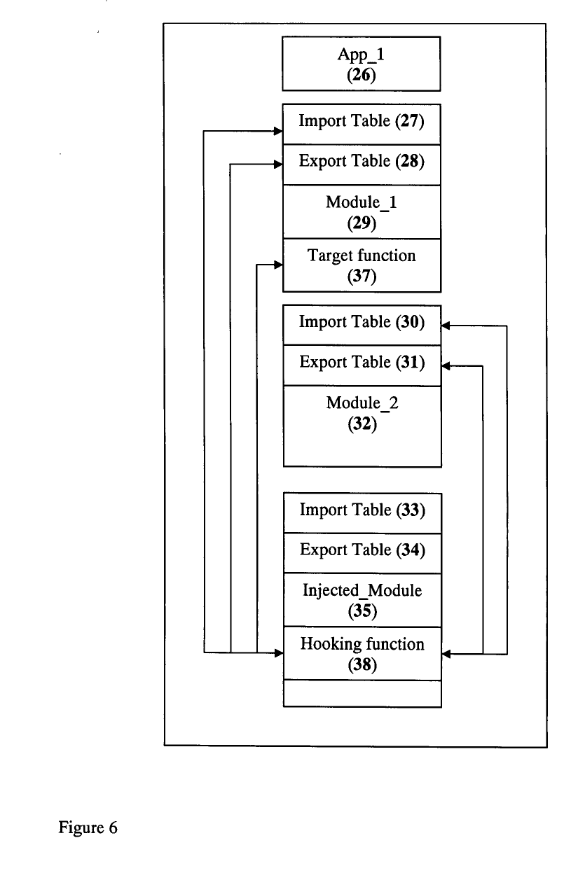

After auditing the internal state of the application, the injected module hooks into several exported or even hidden application programming interface (API) function calls. FIG. 6 shows how the injected module intercepts the targeted API function calls to create a sandbox. A few examples of the hooked API functions are CreateFileW, CreateProcessW, CreateProcessInternalW, Send, Recv, etc. Hooking into these functions enables the injected module to intercept all attempts to read or modify files, registries, network connections, and create/remove processes. The API functions can be either user mode or kernel mode functions and the hooking can be done anywhere along the entire chain for that API function call. The interception of the API function calls can be done in the import table 27, 30 export table 28, 31 or even the body of modules 29, 32.

The injected module loads the sandbox rules from another process or locally stored policy files or a network device. These rules are enforced by the injected code by blocking, permitting, or monitoring the API function calls at the application layer and at the kernel layer.

However, in some cases it is possible to make direct kernel-mode API function calls from the application and that enables the malware, application or module inside an application, to bypass the application layer hooks created by the sandbox. To overcome this shortcoming, the sandbox has another component that resides not inside the application, but in the kernel. A second piece of the sandbox module is injected into the kernel that hooks into kernel-mode API function calls or even unexported API calls and monitors various components of the Kernel. This not only enhances the sandbox enforcement for the applications, but it serves an even more important function of being able to detect any rootkit or malware that may compromise the application layer component of the sandbox.

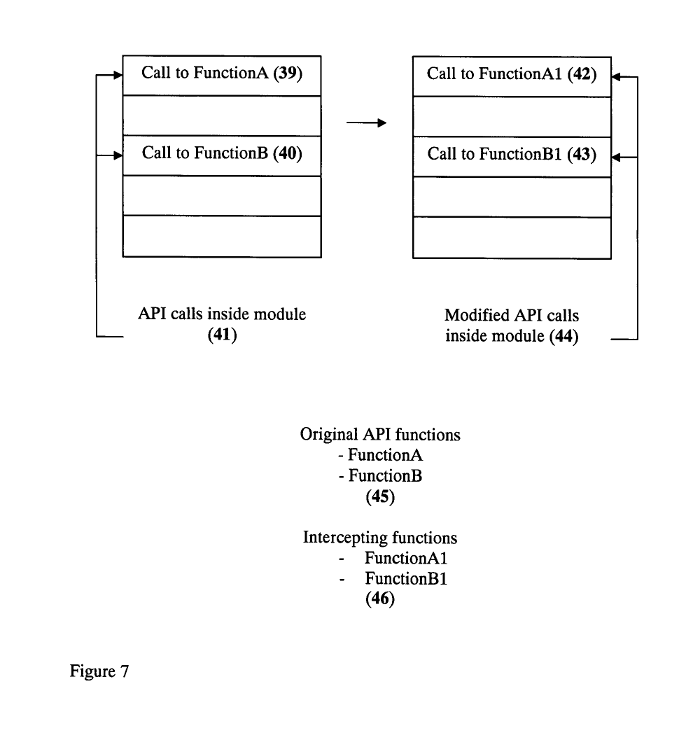

Implementation of the sandbox inside the kernel is a little different from the application layer, but the principle is same. The slight difference arises because it is possible to load applications or modules inside the kernel so that it does not appear as a separate application. These modules are known as drivers. Because drivers execute as part of the kernel, they have full access to memory, direct access to kernel-mode APIs, and greater privileges. Therefore, a malicious driver can do significantly more damage compared to an application. Unlike an application, it is not possible to inject a module into the driver and create a sandbox. As shown in FIG. 7, we overcome this obstacle in creating a sandbox for module or driver in the kernel by scanning the memory space of the driver and hooking into the API calls made by the driver.

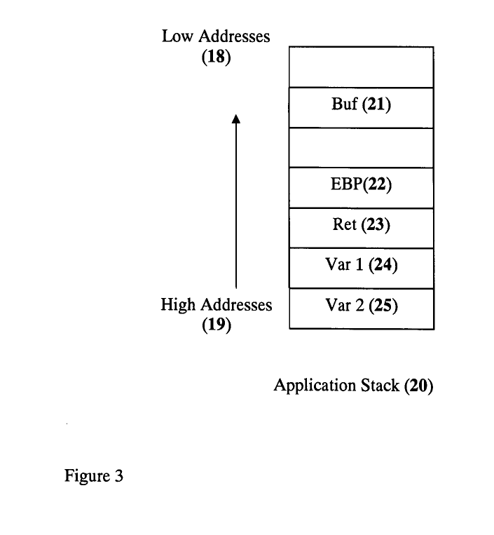

To make an association between the API call and the driver module, inline hooks for the API calls are created by replacing the API call with an intercepting API call. Inside the intercepting API call, the return address on the stack or a cookie is examined that to determine the identity of the kernel module that made the API call. The x86 architecture traditionally uses the EBP register 22 to establish a stack frame, as shown in FIG. 3, and from that we can obtain the return address 23 stored in the registers which in turn yields the identity of the module responsible for that API function call. Same method can be applied to any other central processing unit (CPU) architecture. Then, based on a rule set, the original API call is allowed to proceed or blocked. With this approach, a sandbox for kernel components, such as drivers, can be created in a manner identical to that for applications. In one embodiment of the present invention the same method to identify modules inside an application responsible for any API function calls is used.

An extension of this method is used to make an association, in kernel, between the observed kernel layer API call and the application that originated that call.

To improve the efficiency of the function API call tracing, the in memory location of all modules is stored in a lookup table. The modules can be a driver, kernel, application, or a dll. Periodic polling and interception of API function calls to create new processes, load drivers in kernel, and loading of modules in process are used to keep the lookup table up-to-date.

Once the injected module 36 is loaded in the application, several methods are used to ensure that the sandbox will intercept the target API function calls. The first method is to patch the import 27, 30 and export 28, 31 tables. Import/export table contains the address of the API functions used by the application are located at the beginning of the application and at the beginning of every module inside the application. Table is located by looking up the portable executable (PE) format. Table patching, must be done for every module inside the application. To patch a function, the import and export function tables are scanned for the target function name. The address of the function is replaced by the address of the function that patches it and the original address of the target function is used by the intercepting function to jump to the appropriate memory location.

One drawback of table patching is that it is possible for a module to make API function calls by address instead of name. That enables it to bypass our intercepting function that intercepts that function call. It is also possible to make an API function call by statically or dynamically obtaining the address of the function and making a call directly. In that case, the used API function will not be listed in the import table.

Inline hooking of the target API function calls is used to ensure that the malware is not able to bypass the sandbox mechanism. These functions reside inside a specific module. For example, kernel32.dll or ntdll.dll in case of Windows OS hosts many of the API functions. The procedure to create an inline hook is:

Find the memory location of the target function

Copy the first few instructions and replace with a jump statement to our function

Perform processing before the target function is called

Execute the copied instructions

Call the target function using a jump

Perform the post processing of the results returned by the target function.

With the application layer component of the sandbox in place, it becomes possible to monitor actions of the application and, if necessary, block them.

Another component of the sandbox exists in the kernel that works in conjunction with the application layer component of the sandbox. Several kernel functions are also hooked using a mechanism very similar to the one used for hooking API functions inside the application. Target functions are primarily related to file manipulation, process creations, network access, registry access, memory access etc.

After the target functions are hooked in kernel, the processing of intercepted API function calls may be done in conjunction with the application sandbox or independently. For application where the application sandbox could not be activated, rely solely on the kernel layer component to provide the sandbox. The correlation between an observed system call and the initiator application is done by finding the current running process. This method is not always accurate because the process executing in memory could change by the time our query is completed.

As we have mentioned earlier, the stack is analyzed to trace the module that originated the API function call. In case it is not possible to trace the module that originated the API function call, the name of current process is obtained and an attempt is made to correlate information from the kernel and application components of the sandbox. If the kernel component of the sandbox has the same information as the application component, then no conflict resolution is required. The conflict is resolved by overriding the kernel information on the executing process because the information gathered by the application component is deemed more reliable. This leaves only one case when there is an access, but the application component yields a negative result because the kernel tagged the incorrect application.

The sandbox sometime makes API function calls and in that case there is potential for the sandbox to interfere with the observed application behavior. To completely decouple the effect of sandbox making API function calls on the application behavior, a temporary rule is added every time the sandbox uses an API function call. When the call is intercepted by the enforcing component of the sandbox, it is able to ignore that call based on the temporary rule that was created. Temporary rules can only be used once or for a limited time.

In one embodiment of the present invention, before the sandbox is enabled or sandbox profile for any application is generated, applications and the kernel are checked for any malicious components. Presence of any malicious components can either change the behavior profile of the application or prevent the sandbox for functioning properly. Therefore, it is important that malware is detected and removed in order for the sandbox to be effective.

The integrity check for the sandbox at the application layer is accomplished in two steps. The first step is to scan the application image on disk and then in memory for any known malware signatures.

Next, a search is conducted for “behavior signatures” during the scan that can either reveal malicious intent or hint at potentially malicious nature. The behavior signatures are collection or sequence of API function calls. The API function calls are detected by searching for the function name and by address. In that case the application or application component is flagged and combined with other runtime behavior to classify it as malicious or harmless. The runtime behavior could be a network access, file creation/deletion, registry modification etc. The “behavior signatures” can be custom tailored to specific type of malware such as keyloggers, rootkits, worms etc.

Once an application or a module is classified as malicious, its one disk, in registry, and in memory attributes are recorded and used to neutralized and remove it. As it will be discussed later, a simple termination of the malware or deletion of its on disk components to eradicate it may not be possible because of regenerative nature of the malware. It is even possible that simple deletion could cause harm to the system.

In one embodiment of the present invention, applications are scanned for unauthorized hooks that can either completely bypass or interfere with the application layer sandbox. Scanning for unauthorized hooks is done in two steps. First, all import and export tables are examined to determine if any pointers are changed. If the pointers are changed, then the observed API function pointer is traced back to find all modules that are hooked into that API function call. After that we examine the memory space of the function to determine if there is a module that is hooked in via inline patching of the function. Any detected hooked modules module could be:

Known good module

Known malicious module

Unknown module

If the hooked module is a known good module, it is ignored. If it is know malicious module, then it should have been flagged during the scanning of the application memory space. The information about which functions the module is hooked into is added to the information regarding the attributes of the malicious module. In the case of unknown module, the module is flagged its information passed to sandbox to monitor its runtime behavior for further analysis. An example of malicious runtime behavior is hiding any information related to a process, file, registry entry, application configuration, or network access.

Next step is to determine if the hooked modules are trying to hide or modify any system resource or information in a malicious way. The resource could be a file, process, network connection, or a registry entry. This is achieved by checking application access to computer and network resources via application and then via kernel layer functions that bypass the application, and finding any discrepancies between the two observations. If a malware inside the application is trying to add, hide, or modify information about files, processes, network connections etc. for an application, its effect will be immediately visible as a discrepancy in the information extracted from kernel layer and from the application layer.

Based on the observed effect, the offending module is tracked by tracing the hooks to the loaded modules. Once the offending module is discovered, its identity and the status of the application are displayed in the graphical user interface (GUI).

It is possible that the application may not behave in a manner that flags it as contributing to potential sandbox breach. To address those cases, information about those modules is kept under a separate list. That list is used by the sandbox to look for additional malicious behavior criteria to flag potential sandbox breach and classify the suspect module as a malware.

Sandbox for applications can also be influenced or breached by malware in the kernel. Before profiling and activating the application sandbox, a scan is performed to detect for kernel layer malware. Detection of kernel layer malware is also based on a combination of signatures and behavior analysis.

Search for kernel layer malware begins with checks for unauthorized hooks into the kernel functions. A statistical analysis of function pointers along and a comparison with clean copy of expected function pointers is used to determine if any module outside the kernel hooked into the kernel function calls. Once a hooked module is discovered, it is flagged and its execution path is traced to discover any other modules that may be hooked into that function.

A black and white list is used to bypass or aid the statistical analysis of potential offending modules. The black/white list may contain other attributes of known good or bad modules and once an anomaly is detected, the signatures from white/black list can be used to confirm the maliciousness or change the classification of a flagged module. In the case of unknown module, the module is flagged its information passed to sandbox to monitor its runtime behavior for further analysis. Modules loaded into the kernel that show anomaly based either on signatures or statistical analysis are flagged so they can be deactivated and removed later. (Add a claim that combines static analysis with runtime analysis to flag malware).

The most difficult of all malware are rootkits that are considered almost impossible to detect or remove are the ones that function as a part of the kernel or application image and not as a loaded module. These malware bypass the traditional methods for detection that try to find unauthorized hooks into system call table or even into functions that are not exported by the operating system by tracing the call to modules that are outside that memory space of that application or the kernel. The methods malware use to startup is to either compromise the on-disk image of the application or kernel, or modify it when the image is loaded into memory. An example of a malware modifying the image as it is being loaded into memory is a BIOS rootkit [16].

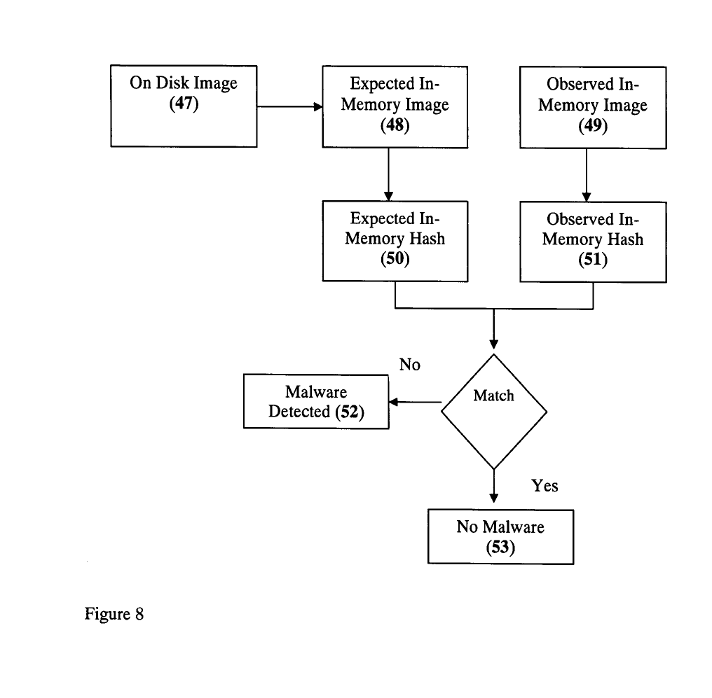

In one embodiment of the present invention, these malware are detected by verifying the integrity of the kernel and of the application images loaded into memory. There are other products in market that solely rely on verifying the integrity of an application image on disk [17], but those solutions can be easily defeated by the mechanism described above. The integrity check method significantly differs from these methods because it first translates the on-disk image to an expected in-memory image 48. As shown in FIG. 8, hash of the expected in-memory image is computed and that hash 60 is compared with the observed in-memory hash 61 of the application or kernel or module image. Any change made to the application or kernel image while it is being loaded into memory, no matter how small, will be identified. Another advantage of this method is that some malware are starting to intercept calls to functions that are not exported by the kernel and even those actions can be identified without having any knowledge about the hidden functions.

Since comparing the hash of entire module, application, or kernel only confirms the breach of integrity of the entire image, it does not yield any information about the potential location of the malware. We overcome this problem by performing the hash check on specific parts of the image to narrow down the location of malware. By dividing the image appropriately, the hash mismatch of a section of image can be correlated or linked to a specific API function call.

Traditional method for malware detection and identification is based on attributes such as name of the file, checksum, strings from the application image etc. These signature-based methods are limited as a small variation in the source code of the malware can render the signature-based method ineffective. Signature-based methods are also ineffective against new malware for which signatures have not been generated. To overcome the limitations of signature-based malware detection, two methods are used for behavior analysis.

The first method leverages the fact that the malware must make certain API function calls, by name or the address, in order to carry out an active or passive malicious act. By searching for a combination or sequence of such API function calls, by name or address, in the memory or disk resident copy of the suspect application, a potential or confirmed malicious application can be identified. Because the application images is scanned for API function calls, it becomes very hard for the application to bypass our detection method and the only way for that malware to evade detection is by not performing the operations that use those API function calls. Sometimes the presence of an API call signature in itself is not sufficient to tag an application as malware, but when combined with run-time actions such as a network connection outside the trusted zone confirms its malicious nature.

Another example of malicious runtime malicious behavior is if the application is making an attempt to hide information. If a malicious application can hide the files, registry entries, and processes associated with it, it can evade detection by most anti-malware tools. Common method to hide information is to either intercept and filter API function call results, inside application or kernel, or to manipulate data structures that hold information about the application. If the malware is intercepting user-mode API function calls to hide information then the present invention will detect it during the application layer sandbox integrity check. If the malware hides information by hooking kernel-mode API calls or directly modifying kernel objects then it can evade detection during the application sandbox integrity check.

In one embodiment of the present invention, malware that hides part or all of its components to evade detection by manipulating kernel objects is also detected. The mechanism to detect malware hidden in the kernel is based on cross checking the observations from multiple sources which gives further insight into the behavior of the application. For example, if a malware hides itself by direct manipulation of kernel objects, then the hidden object will not be visible in the list of running process, but if it makes a network or file system access then it will be detected because there will be no corresponding application available in the list of running processes. The malware will be detected by checking for any attempts by applications to hide information.

A module is injected into each application that uses API function calls to obtain the list of running processes, registry entries, network connections, and file names. Same information is obtained independently by making kernel API function calls that bypasses all applications. If the kernel API used by us is not hooked by any other module, it is deemed more reliable. If there is any attempt to hide information from applications, it will show up as a discrepancy between the information gathered by the applications versus the one obtained via native API calls.

This method described in one embodiment of present invention is complimentary to some published accounts for detecting hidden kernel objects by hooking into the context switch function and observing the processes that go in and out of execution context to generate a list of running processes. This list should be identical to the list visible to other applications and can be used to detect hidden processes. Advantage of the present invention is that it does not require access to kernel functions that are not exported.

Malware in the kernel layer that is a driver can take certain actions that make it even more difficult to detect because some of the actions may happen before anti-malware software have begun to function. For example, it can remove itself from a list of drivers that start on reboot or it can remove a startup application from the registry and disk after the startup application starts the driver. This enables the driver and the startup application to remain hidden from malware scanning software. The driver can restore the startup registry and write the file to the disk at the time of reboot to remain in stealth mode. Such kernel layer malware is identified by checking for inconsistencies between the startup list for drivers in the registry compared to the one in the memory. A check for startup items that were removed during the startup and inserted during the shutdown is also made to find stealth malware. This is achieved by a driver installed that starts before any of the startup applications and can detect changes to the startup application list at all times.

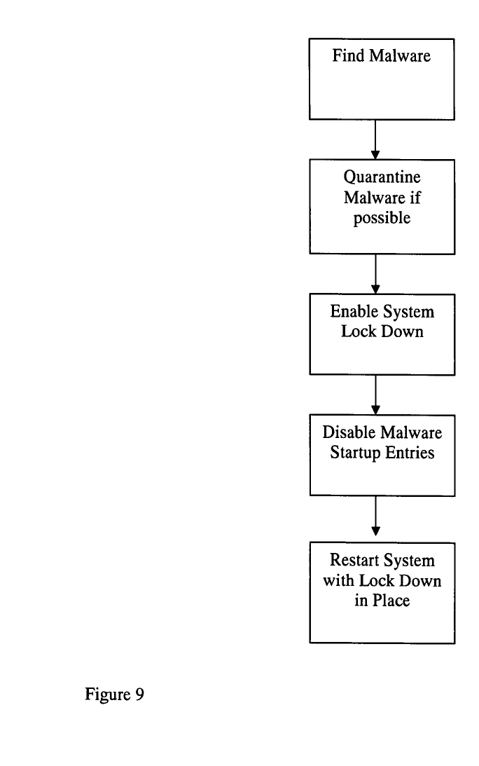

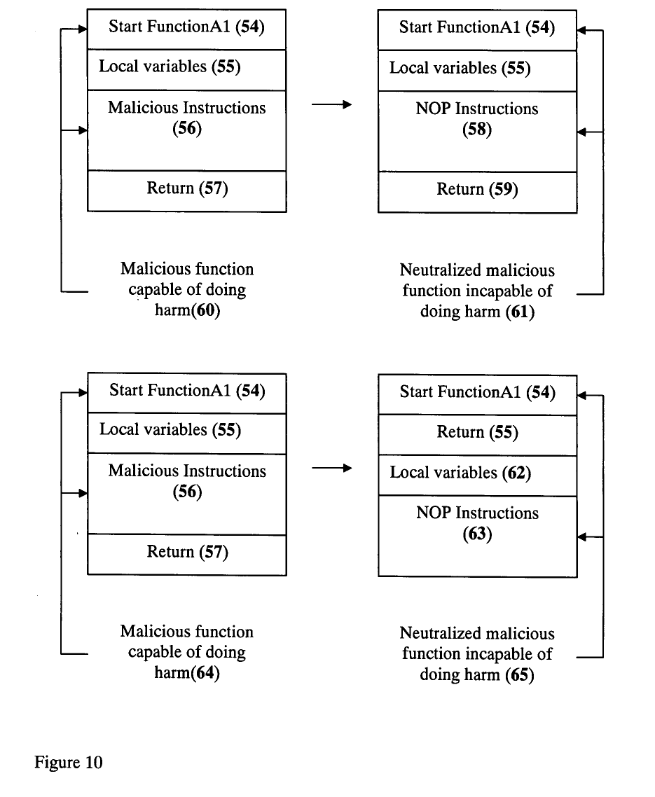

Once a malware is detected, in kernel or in application, it is to be deactivated before application profiling. As shown in FIG. 9, the deactivation of the malicious component has several steps:

Quarantine the application

Removal of malicious module from the application

Terminate the malicious application

Prevent re-start of the application and system lock down

Removal of malicious components from the kernel

Removal of all on-disk signatures of the malware

Preventing regeneration of the malware

Reboot or restart

If the malware is at the application layer in the form of a malicious or infected application, it is quarantined by tightening the sandbox. Once the application is quarantined, it simply cannot take any action that is controlled by the sandbox. The quarantined application will not be able of read or write files, make network connections, read or write registry entries, and launch any executable code. The sandbox is able to prevent the quarantined application from being able to leak and information or cause any damage to the system as long as the sandbox is configured correctly. Thus, the malware at application layer can be effectively neutralized. After quarantining the application, its traces in files and registry can be deleted and the application terminated to remove the infestation and prevent it from restarting. Even most regenerative malware can be contained and removed using this method.

There are two instances when the application layer sandbox will not be able to quarantine the application layer malware, especially if the malware has regenerative or rootkit properties. These instances are:
Malware is in an application that is not or cannot be sandboxed
Malware is able to breach the sandbox at application layer

Because the malware is at the application layer, it will not be able to circumvent the sandbox component that is resident in the kernel and we can use it to solve these two cases. Since the kernel component of sandbox hooks into API function calls for file or registry manipulation and process creation, we are able to prevent the malware from starting a new instance of itself or another malware. With the protection form the kernel component in place, we terminate most, if not all, known executing components of malware. However, it is possible that the sandbox may reside in applications that that cannot be terminated or do not have the application layer sandbox protection. A global restriction is placed on actions that can result into regeneration of malware. These actions are creation of new process or threads, addition or modification of startup application entries in the registry, and writing executable code to the disk. With the malicious code quarantined using the application and kernel components of the sandbox and having its regenerative capabilities eliminated, we force the machine to restart. When the machine restarts the malware will not be active and now its traces in the file system and registry entries can be cleaned easily.

FIG. 9 outlines one embodiment of this approach that can be used to disable and remove malware that cannot be removed using traditional methods.

Using the kernel layer component of the sandbox to enforce a global lockdown and reboot, while works, may not be desirable in certain situations. This drawback can be overcome by erasing the malware application or module in memory by overwriting its image or trapping all its functions to a null function.

The method of trapping all functions or deleting the in memory copy is also effective against malware in the kernel. Malware inside the kernel is more difficult to deactivate or remove because it can be loaded as a driver that cannot be easily quarantined, sandboxed, or terminated easily like applications. Drivers, unlike applications, cannot be terminated or quarantined easily because they are loaded into the kernel, they execute as part of the kernel and cannot be terminated, in most cases, until the machine is restarted. Unlike the application layer malware that can be contained and neutralized with the aid of the kernel layer sandbox, a regenerative malware inside kernel can take evasive actions that can potentially bypass the protection mechanism of the kernel layer sandbox.

For example, with an inline hook into a kernel API function call to block a file or process or registry access, the kernel layer malware can replace sandbox hooks with its own hooks. This can lead to a race condition with no guarantee that even a perfect method to contain malware and to enforce our sandbox in the kernel can remove the piece of offending malware.

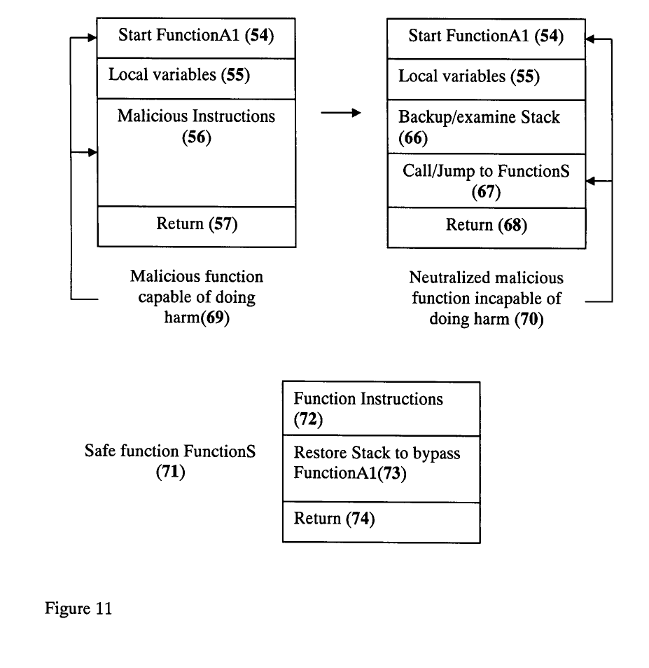

In one embodiment of the present invention, this problem is overcome by preventing the execution of the offending code, deleting in memory, and, if necessary, on the disk as well. Two methods are used to prevent the execution of the thread in memory. In the first method that is shown in FIG. 11, the entire memory space is scanned to find jump instructions that point to a location inside the memory space of the malware module. Those jump instructions are replaced with jump instructions into trap function that performs no malicious actions. With this method it becomes possible to prevent any part of the malware code from being executed.

In the second method that is shown in FIG. 10, the malware code is deleted in memory. Once the code is deleted in memory, its ability to do anything is completely eliminated even if the sandbox is not perfect. Deletion of the offending code in memory is achieved by either:

Overwriting the export table of the offending code with our own function that performs no operations and unwinds the stack before returning.

Overwriting all or part of the functions of the offending or malicious code 56 with NOP 58, 63 instructions inserted in place of the original executable code.

The overwriting of all exported functions is done only after the execution of the threads has completed. When a function is overwritten with NOP instructions, it is sufficient to overwrite the function after the local variables are initialized, but it is not necessary.

While it is possible to come up with variants on how to neutralize malicious code in memory, couple of examples will illustrate the general principles. For anyone well versed in the art, it will become obvious on how to create other variants. In the first example shown in FIG. 10, a return instruction 59 is inserted that unwinds the stack correctly as the very first instruction. The rest of the function code can be left as is or replaced with NOP instructions or some other instructions as it will never get executed. If so desired, a return instruction can be inserted that prevents execution of any code inside that function, but care must be taken to remove appropriated bytes from the stack.

As shown in FIG. 11, another variant is to insert a JMP or CALL 67 to another location in memory before any code form the malicious function can be executed. The jump to safe function 71 restores the stack in a fashion that the return from the safe function completely bypasses the malicious instruction. Depending on where the JMP or CALL instruction is inserted into the function, it becomes necessary to remove data from the stack correctly so that return from the trapping function bypasses the malware function.

Before these rules can be applied they must be generated and tested to ensure proper functioning and security for the application. The application behavior profiling uses the same basic principles employed in malware detection. Application and kernel functions are hooked and the behavior of the application is monitored. A “Learn mode” is used to silently watch the access made by the application without enforcing any rules.

The accesses made by applications are automatically translated into rules for the sandbox. For every rule added this way, statistics are collected on how the rule was used. After the “Learn mode” has been completed, the generated rules are examined to determine if the sandbox need any tweaking. To simplify the process for conversion to rule, a risk factor is assigned to each rule. The “risk factor” coupled with the “usage frequency” aids the user in making the correct decision if they should keep or eliminate the rule.

After the “learn mode” has been completed and statistics and risk factor for the rules have been generated, a risk profile score is generated for each application. This risk profile score is an indicator of how vulnerable the application is based on current sandbox rules. The score is generated by algorithmic and statistical merging of the “risk factor” for the stored rules for that application.

A common concern about third-party or even open source applications installed on computers is that it is near impossible to determine if there are any hidden malicious components that may case harm. In one embodiment of the present invention, the application sandbox is able to monitor and contain application behavior. By analyzing the information on how the application interacts with the system, local actions it takes, and information it exchanges with the outside world, it is possible to assign a risk factor to those observed or expected actions. The risk factor for the application is computed via a mathematical function that takes the risk factors as input. In its simplest form, it can be a simple weighted sum of “threat level” scores assigned to various API function calls and actions.

Some of the actions that can be considered risky by a new or existing application are:

Writing a kernel driver file or an application executable to the file system

Starting a driver or service

Creating a new startup item

Based on some of this observed risky behavior an appropriate risk score can be assigned to that application. If the risk score of an application exceeds a certain threshold then the application can be terminated.

A big problem with using a sandbox to contain the behavior of application is that sandbox rules are rigid. Sandbox based malware control, while able to contain the behavior of application, has a limit. If an application exceeds the sandbox rules, because the rules were not generated correctly, the application may misbehave even though there is no malware or threat. Additionally, if a piece of malware is found inside a critical application with a large sandbox, then it still leaves the system vulnerable and if the sandbox is tightened, the result may be undesirable performance. For example, if an application needs significant access to the file system then the sandbox will have limited ability in controlling damage to the file system in case a malware is able to infect the application. This becomes a major source of concern for critical system applications.

This problem is overcome by using two methods that enhance the effectiveness of sandbox. These two methods are:

Sandbox flexibility

Statistical decision making

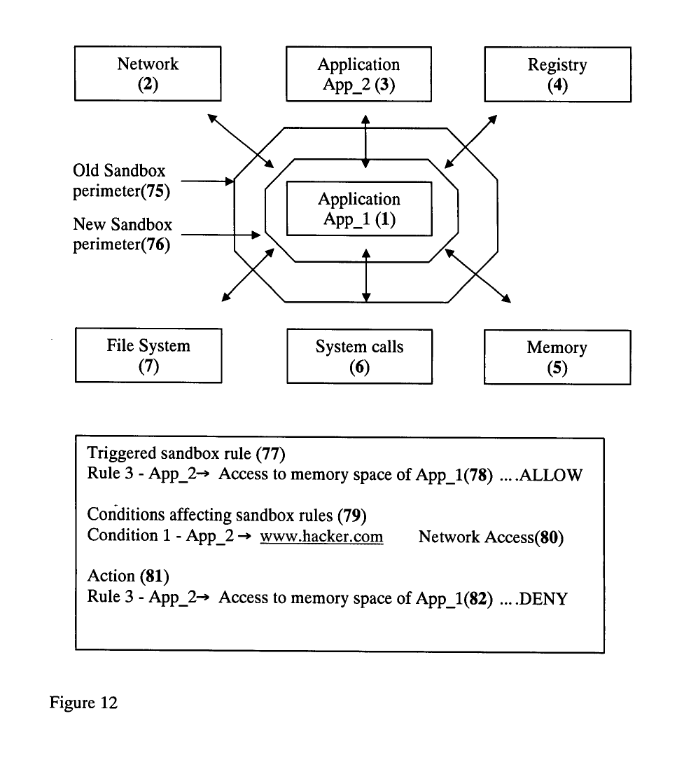

Sandbox flexibility can be used to dynamically adjust the sandbox parameters to enhance the security based on parameters such as executing code, signatures inside executing code, location from where the code was downloaded, identity of the module being executed etc. FIG. 12 shows how sandbox parameters change can increase or decrease the sandbox size.

For example, if the application downloads an external module that is deemed untrustworthy, the sandbox size can be reduced while code of that module is being executed. With such a flexible sandbox, it becomes possible to give more freedom to trusted code to allow the application to function properly while reducing or eliminating the chances that an untrusted module loaded into the application can cause damage.

An example of application of this principle is in the web browser that can download modules, such as an ActiveX control, from websites and execute them inside the web browser. Since the downloaded module executes as part of the web browser, it gets the same access to the system as the web browser and can potentially cause damage. By tightening the sandbox 76 from its original setting 75 if the downloaded module is being executed, the downloaded module can be prevented from causing any damage to the system.

The mechanism by which sandbox size is changed based on executing content can be done in two ways. The first method is to explicitly specify the sandbox rules for modules being executed inside the application. While this approach provides a very high level of granularity, it quickly becomes impossible to manage.

Another method is to use a mechanism that can quickly classify modules inside the application into several categories and then apply a few very restrictive rules on those categories. For example, a downloaded ActiveX may not be allowed to delete any file on the system and create new processes, but it can make network access. In addition, statistical risk analysis mechanism is used to determine the trustworthiness of the module. This method effectively works as an exception to the sandbox rules and is more practical.

Even though adding exceptions to sandbox conditions can improve security, it is still cumbersome and not comprehensive enough. The difficulty in statistical modeling lies in translating obvious logical circumstances that a human being can understand into mathematical variables and equations that would closely mimic the response of the human.

For example, if the application is trying to read a file that is disallowed by the sandbox rules, but currently the application has no network connections, executing module is trusted, and no unknown modules are loaded into the application, then there is very little or no reason to believe that the action by the application is going to be dangerous. There are cases where the executing code is trusted, but the data supplied to it comes from an untrusted source and that result into an exploit. Such exploits can be thwarted by assigning a high risk score to an interaction between an application connected to external network and another application on the same device or network. This mechanism is used to translate actions or API function calls into a mathematical variable.

A statistical threat modeling method is used to create exceptions to sandbox rules is used where the hard edge of the sandbox is adjusted by using functions that use system state as normalized input variables. Input variables are based on a threat level assigned to quantities such as network/file/registry access by application, currently executing module etc. Based on these parameters together, a decision is taken to allow or block an action that is outside the sandbox.

Since that is a very complex task that may not have an exact solution, approximation via linear weighted sum is used that yields very good results for all practical purpose. For someone familiar with the art, it should be clear that the method can use any other mathematical approximation, e.g. Bayesian theorem.

Thus, it is seen that systems and methods for (repeat the problem that you are solving) are provided. One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims. The fact that a product, process or method exhibits differences from one or more of the above-described exemplary embodiments does not mean that the product or process is outside the scope (literal scope and/or other legally-recognized scope) of the following claims.

### REFERENCES

[1] A. Margosis, ““Zero-day” attacks and using limited privilege” http://blogs.msdn.com/aaron_margosis/archive/2004/06/25/166039.aspx
[2] N. Ray, “Bugwatch: Next-generation ‘zero-day’ attacks. http://www.vnunet.com/vnunet/news/2127268/bugwatch-generation-zero-day-attacks
[3] G. Hoglund, J. Butler, “Subverting the Windows Kernel”
[4] D. Brown et al, “Computer Security System.” U.S. Pat. No. 7,013,485.
[5] Mueller, et al, “System and method for securing a program's execution in a network environment.” U.S. Pat. No. 6,351,816.
[6] Vaswani, et al, “Web host providing for secure execution of CGI programs and method of doing the same.” U.S. Pat. No. 6,308,275.
[7] Bond, et al, “Security enhancement for untrusted executable code.” U.S. Pat. No. 6,275,938.
[8] Shostack, et al, “Computer Security.” U.S. Pat. No. 6,298,445.
[9] Rechef, et al, “Method and system for maintaining restricted operating environments for application programs or operating systems.” U.S. Pat. No. 6,199,181.
[10] Brickell, Ernie F et al., “Method for improving computer security through sandboxing,” US patent application 20060021029.
[11] R. Naraine, “Microsoft Says Recovery From Malware Becoming Impossible” http://www.eweek.com/article2/0,1895,1945782,00.asp
[12] G. Keizer, “Rootkits To Mask Most Malware By 200838 http://www.techweb.com/wire/security/186500795;jsessionid=IXU4HGOY1A11A QSNDBCSKH0CJUMEKJVN
[13] Chen, et al, “System, apparatus and method for the detection and removal of viruses in macros.” U.S. Pat. No. 5,951,698.
[14] Shetty, et al, “Protocol-level Malware Scanner.” U.S. Pat. No. 6,772,345.
[15] Wells, et al, “Authentication program for a computer operating system.” U.S. Pat. No. 6,779,117.
[16] BIOS Rootkit http://www.ngssoftware.com/jh_bhf2006.pdf
[17] Tripwire http://www.tripwire.com/solutions/index.cfm

What is claimed:

1. A method for monitoring behavior of plurality of applications or modules in a computing device, comprising the steps of:
injecting a module into the memory space of the said applications;
the injected module monitoring said applications' file system accesses by intercepting API function calls via imported or exported functions table patching and inline hooking of functions at the application layer;
the injected module monitoring said applications' network accesses by intercepting API function calls via imported or exported functions table patching and inline hooking of functions at the application layer;
the injected module monitoring said applications' executable content loading by intercepting API function calls via imported or exported functions table patching and inline hooking of functions at the application layer;
the injected module monitoring the memory access by the applications via inline hooks in API function call and the application programming interface functions provided;
and the injected module monitoring the registry access by the applications via inline hooks in API function call and the application programming interface functions provided.

2. The method of claim 1 wherein the behavior monitoring method is applied to a specific module inside the application.

3. The method of claim 1 wherein the API function calls are first checked for unauthorized hooks by examining the API function pointers in memory to obtain and display the identities of the modules that are intercepting the API function calls.

4. The method of claim 1 wherein the behavior monitoring method is applied to a specific module inside the kernel.

5. The method of claim 1 wherein the behavior monitoring method is used in a special learn mode where and the observed application behavior is used to generate the rules for sandbox.

6. The method of claim 1 wherein the behavior monitoring method is applied to a specific module inside the application as it relates to its interaction with another module.

7. The method of claim 1 wherein the observed behavior of the application over a time period is displayed in charts.

8. A method for restricting the behavior of plurality of applications or a modules inside an application comprising the steps of:
injecting a module into the memory space of the said application;
loading a rule base into the said module that identifies specific behavior boundaries;
the injected module blocking or allowing said applications' or modules' file system accesses by intercepting API function calls via imported or exported functions table patching and inline hooking of functions at the application layer based on the rule table;
the injected module blocking or allowing said application's or modules' network accesses by intercepting API function calls via imported or exported functions table patching and inline hooking of functions at the application layer based on the rule table;
the injected module blocking or allowing said applications' or modules' executable content loading by intercepting API function calls via imported or exported functions table patching and inline hooking of functions at the application layer based on the rule table;
the injected module blocking or allowing the memory access by the applications' or modules' via inline hooks in API function call and the application programming interface functions provided based on the rule table;
and the injected module blocking or allowing the registry access by the application via inline hooks in API function call and the application programming interface functions provided based on the rule base.

9. The method of claim 8 wherein the application actions are blocked or allowed based on additional information about the current network connections.

10. The method of claim 8 wherein the application the application is permitted or denied download a specific file type from a remote machine, domain, or IP address.

11. The method of claim 8 wherein the application actions are blocked or allowed based on additional information about other processes executing on the computer.

12. The method of claim 8 wherein the API function calls are checked for unauthorized hooks before the sandbox is installed by examining the API function pointers in memory and obtaining the identity of the module, if any, that is intercepting the function API call.

13. The method of claim 8 wherein the API function calls are checked for unauthorized hooks at fixed time intervals by examining the API function pointers in memory and obtaining the identity of the module, if any, that is intercepting the function API call.

14. The method of claim 8 wherein the behavior restricting method is applied to a specific module inside the application.

15. The method of claim 8 wherein the behavior restricting method is applied to a specific module based on the identity of source or target module affected by it.

16. The method of claim 8 wherein the behavior restricting method is applied to a specific module inside the kernel.

17. The method of claim 8 wherein the behavior restricting method and rules for any application are applied to any process created by the said application.

18. A method for restricting the behavior of an application or a module in kernel comprising the steps of:
scanning the in memory image of the application or kernel module for native API function or unexported API function calls;
inline hooking of the API function calls by overwriting the first few instruction sets with a jump statement to the intercepting API call;
examining the stack in the intercepting API function call to obtain the return pointer of the function;
using a lookup table to determine the kernel module or application identity based on the return address;
using a rule based to allow or permit intercepted API function calls.

19. The method of claim 18 wherein the API function calls to be intercepted are checked for unauthorized hooks before the sandbox is installed by examining the API function pointers in memory and obtaining the identity of the module, if any, that is intercepting the function API call.

20. The method of claim 18 wherein the API function calls to be intercepted are checked for unauthorized hooks at fixed time intervals by examining the API function pointers in memory and obtaining the identity of the module, if any, that is intercepting the function API call.

21. A method for removing the effect of sandbox actions on the sandbox for an application or a module comprising the steps of:
generating temporary rules to permit access when an API function intercepted by the sandbox is used by the sandbox;
analyzing the stack when the API function call is intercepted by the sandbox to determine if the call was generated by the sandbox;
permitting the API function call and deleting the temporary rule.

22. A method for detecting malware, hidden or otherwise, that may compromise effectiveness of sandbox, comprising the steps of:
scanning the on-disk image of plurality of applications and kernel modules for any malware signatures;
scanning the in-memory image of plurality of applications and kernel modules for any malware signatures;
scanning the import and export function table for all modules inside any application or kernel for unauthorized hooks;
scanning the code section of every module in memory for any unauthorized hooks;
scanning module binary in memory for sequence of API function calls that may indicate potential malicious intent and storing that information so that it can be combined with run time behavior.

23. The method of claim 22 wherein the import and export function tables inside an application are examined by another application by opening the memory space of the said application.

24. The method of claim 22 wherein the import and export function tables inside an application are examined by a module injected into the memory space of the said application.

25. The method of claim 22 wherein the import and export function tables inside an application are examined by the operating system at a predefined time or after fixed time intervals to detect any changes.

26. The method of claim 22 wherein an instance of run time behavior of application or module is used in combination with the scanning of application or module binary to flag compromise of sandbox.

27. A method for detecting malware based on its expected behavior derived from the action signatures in application module on disk or in memory comprising the steps of:
defining a sequence or combination of function names that can be characterized as a malware;
scanning the application module in memory and on disk for the defined sequences or combinations;
recording the on disk and in memory location of the modules with the defined sequence or combinations of function names.

28. The method of claim 26 wherein the function pointer is searched for instead of the function name.

29. A method for detecting malware hidden inside the kernel image or application image in memory comprising the steps of:
computing hash of the application or kernel image on disks that includes only the executable code component after all the physical memory references have been updated to appropriate virtual memory references;
computing the in memory hash of the application or kernel image;
comparing the two hashes to detect if the application or kernel image loaded in memory has been modified.

30. The method of claim 29 computed and compared with a previously computed or independently obtained 23 wherein the hash of the entire on disk image of the application or kernel is has to ensure that it has not been tampered with.

31. The method of claim 29 wherein this mechanism is applied to any module loaded in memory.

32. The method of claim 29 wherein this mechanism is applied to parts of application or kernel image that contain executable code.

33. The method of claim 29 wherein this mechanism is applied to only a part of the module to localize the malware or unauthorized hook.

34. The method of claim 29 wherein the hash mismatch is traced to a specific API function call by comparing the memory location of the API function call pointer and the memory range for which hash is computed.

35. A method for detecting keyloggers on a computing device, comprising the steps of:
scanning the in memory and on disk image of the application for API function calls that intercept key strokes;
scanning the in memory and on disk image of the application for API function calls that enable it to make network connections;
monitoring the runtime behavior of the application to detect network connections outside the local area network.

36. The method of claim 35 wherein scan searches for the pointer to the API function call instead of the name.

37. The method of claim 35 wherein scan searches for API function call, by name or address, that attempts to obtain the address of the API function that intercepts key strokes made by the user.

38. A method for uncovering malicious intents of an application or a module inside an application or kernel comprising the steps of:
injecting a module into the memory space of the said application;
the injected module obtaining the complete or partial list of files, current processes, network connections, and registry entries by making appropriate application API function calls;
the injected module or another application obtaining the complete or partial list of files, current processes, network connections, and registry entries by directly making appropriate kernel function calls;
using the discrepancy to obtain a list of files, processes, network connections, and registry entries that may be hidden from applications;
tracing the API function call to determine the identity of the module responsible for hiding the information.

39. The method of claim 38, where the injected module first analyzes the pointers to the API functions calls that it uses with those in the other modules in the application and corrects any inconsistencies therein.

40. The method of claim 38 where a hidden malware is uncovered by performing a consistency check between the observed API function calls in kernel layer and application layer.

41. A method for removing malware, Trojans, keyloggers or Rootkits, comprising the steps of:
restricting the identified malware application via inline hooks into API function calls made by the malware and rejecting them to prevent it from taking certain action that include, but not limited to, creating new process, accessing memory space of other applications or kernel, accessing network, and accessing the file system;
preventing modifications to the area of registry or file system of the computer that may enable the malware to start itself upon rebooting of the device by intercepting application and kernel layer calls;
forcing the system to restart while keeping the lockdown in place during the shutdown process to prevent actions taken by malware.

42. The method of claim 41, wherein creation of any new process is prohibited by intercepting the API function call for creating new processes.

43. The method of claim 41, wherein injection of a module into the memory space of any executing application is prohibited by intercepting the API function call for loading modules.

44. The method of claim 41, wherein the lockdown is either enabled manually, or automatically based on type of malware detected.

45. The method of claim 41, wherein creation of the malware process or loading of the malware module is restricted after the device restarts by intercepting the API function calls for creating new processes and loading modules.

46. The method of claim 41, wherein any attempts to write, create, or modify executable files to the file system are denied by intercepting the user mode or kernel mode API function calls.

47. A method of neutralizing a malware in memory comprising the steps of:
obtaining the start and end location of the malware in memory either from the process handle of the process it is part of or from the loaded driver list;
scanning the module for function start and function end locations;
modifying all functions by replacing the executable instructions sets, with NOP instructions;
modifying the return instruction at the end of each function so that the missing local variable declaration due to insertion of NOP instruction does not adversely affect the stack unwinding procedure.

48. The method of claim 47, wherein the start of the function is replaced by unconditional return, before or after any local variable declaration, that unwinds the stack properly based on the local variable declaration prior to the return instruction.

49. A method of neutralizing a malware in memory comprising the steps of:
obtaining the start and end location of the malware in memory either from the process handle of the process it is part of or from the loaded driver list;
scanning the module for function start and function end locations;
replacing the first few instructions of the function with a JMP or CALL to a trap function after counting the local variable declaration up to that point and storing that information in a register;
modifying all functions by replacing the executable instructions sets contained therein, in part or in entirety, with NOP instructions.

50. The method of claim 49, wherein the stack is modified in the trap function by removing appropriate number of bytes so that the return bypasses the malware function and directly returns to the function that called the malware function.

51. The method of claim 49, wherein the entire memory of the computing device is scanned for CALL or JMP instruction into the malware function range and redirecting those CALL and JMP instructions to a trapping function.

52. A method for ascertaining the risk level for any application or a module comprising the steps of:
identifying the hooks placed by the application or the module into the API function calls and using a state machine to assign a threat score to it;
identifying traces of malicious activities in the sandbox intercepted API function call logs for the application;
recording any critical changes made by that module or application including but not limited to writing executable code to disk or memory, creating startup items, starting new services or drivers or application;
generating a report on the potential attack mechanism used by the application that shows the attack vector used by the application to leak data or cause damage.

53. The method of claim 52, wherein the threat score from the state machine examining the API function calls placed by the module.

54. The method of claim 52, wherein the risk level of all new or unknown application or module is ascertained and the execution of the module is terminated if the associated risk level exceeds a threshold.

55. A method to allow or permit and API function call based on the identity of the source module and a rule set comprising the steps of:
creating a function that will hook into the target API function call, performs preprocessing on the data input to the API function call, and post processing to the data obtained from the API function call;
examining the stack within the function that intercepts the API function call to obtain the address of the return pointer located on the stack;
obtaining the name of module corresponding to the return address;
using the rule table to allow or deny the API function call.

56. The method of claim 55, wherein start and end address of every module is recorded in a lookup table and that table is used to determine the identity of the module responsible for originating the API function call.

57. The method of claim 55, wherein the identity of module that originated the API call is made by dynamically obtaining it.

58. The method of claim 55, wherein an association between the intercepted kernel layer API function and its originator in the application layer is made by examining the kernel stack to trace the corresponding stack in the user layer, obtaining the return.

59. A method for assuring the integrity of the sandbox at application or kernel layer comprising the steps of:
storing the information about all API functions hooked by the sandbox;
periodically checking information about the hooked API functions with the stored information;
generating a notification event if a mismatch is found.

60. The method of claim 60, wherein the stored information about the hooked API functions includes the memory locations and the values.

61. A method for creating a lookup table to obtain the process or module name based on a pointer comprising the steps of:
opening the memory space of all current processes;
periodically checking information about the hooked API functions with the stored information;
generating a notification event if a mismatch is found.

62. The method of claim 61, wherein creation of new process or removal of existing process event is used to update the lookup table.

63. The method of claim 61, wherein loading of new module or unloading of an existing module in a process event is used to update the lookup table.

64. The method of claim 61, wherein loading of a new module in kernel or removal of an existing module form the kernel event is used to update the lookup table.

65. A method for creating a flexible sandbox comprising the steps of:
creating a sandbox rule set wherein exceptions to any sandbox rule can be specified that can override the action as prescribed by that sandbox rule;
listing additional conditions that can lead to the exception;
for any intercepted or monitored event, matching the related sandbox rule to determine the prescribed action;
determining the effect of conditions on the sandbox rule and, if necessary, altering the prescribed action.

66. The method of claim 65, wherein the same exception conditions are applied to all sandbox rules.

67. The method of claim 65, wherein the exception to any sandbox rule is generated based on a mathematical expression.

68. The method of claim 65, wherein the exception to any sandbox rule is generated based on a logical expression.

69. A statistical method for decision making to control sandbox, comprising the steps of:
assigning a threat score to plurality of events intercepted by the sandbox and observed conditions;
building a correlation table between an event classified as attacks and plurality of events intercepted by the sandbox and observed conditions;
using a mathematical expression to which the normalized threat scores of intercepted events and observed conditions are input and its output closely approximates the presence of absence of an attack or malicious activity.

70. The method of claim 69, wherein a linear weighted sum is used to combine the individual threat scores to determine attack or malicious activity.

71. A method controlling interaction between one or more modules inside an application comprising the steps of:
opening the memory space of the process or kernel the modules reside in;
creating a sandbox for plurality of modules inside that process or kernel by intercepting API function calls by that module by replacing function calls from the module and hooking of the API function calls with stack analysis to determine the originating module;
creating rules to control the access of a module's resources by another module;
permitting or denying actions initiated by a module by the sandbox for another module based on the rule set stored by the sandboxes of respective modules;

72. The method of claim 71, wherein the blocking of action taken by a module is by another module in a different application.

73. The method of claim 71, wherein the blocking of action taken by a module is by another module in the kernel.
